(19) United States
(12) Patent Application Publication
(10) Pub. No.: US 2022/0386438 A1
(43) Pub. Date: Dec. 1, 2022

(54) Device and Method for Wirelessly Testing Vehicle Lights

(71) Applicant: Kyle Hansen, Sterling, NE (US)

(72) Inventor: Kyle Hansen, Sterling, NE (US)

(21) Appl. No.: 17/405,184

(22) Filed: Aug. 18, 2021

Related U.S. Application Data
(60) Provisional application No. 63/192,608, filed on May 25, 2021.

(51) Int. Cl. H05B 47/19; B60Q 1/30; G08B 5/38

(52) U.S. Cl. CPC H05B 47/19; B60Q 1/305; G08B 5/38; B60Q 11/005

(57) ABSTRACT

The present invention relates to a system, device, and method for checking functionality of tail lights, brake lights, and turn lights of a vehicle and/or a connected trailer. The invention includes a key fob device that wirelessly connects with a vehicle's on-board light control module (i.e. ECU). The key fob can be used from outside of the vehicle to transmit wireless instructions to flash or actuate tail lights, brake lights, and turn lights for a predetermined time enabling a user standing behind the vehicle to check the functionality of the lights of the vehicle. The user can activate control buttons on the key fob to selectively activate tail lights, brake lights, and turn lights. The present invention eliminates the need to ask for assistance to check functionality of vehicle lights or spend time getting in and out of a truck cab to check the lights while alone.

### CROSS-REFERENCE TO RELATED APPLICATION

The present application claims priority to, and the benefit of, U.S. Provisional Application No. 63/192,608, which was filed on May 25, 2021 and is incorporated herein by reference in its entirety.

### FIELD OF THE INVENTION

The present invention relates generally to the field of testing devices. More specifically, the present invention relates to an operating vehicle light check assistance device that is a multipurpose key fob device configured to allow a user to independently check tail lights, turn signal lights and/or brake lights on a vehicle or trailer. The key fob comprises plurality of buttons to remotely check functioning of different lights, while eliminating the need to ask for assistance to check functionality of vehicle lights or spend time getting in and out of a truck cab to check the lights while alone. The tail light check assistance device of the present invention improves overall roadway safety and prevents serious accidents from occurring due to being unaware of malfunctioning vehicle lights. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, vehicles have a number of exterior vehicle lights, such as turn signals, brake lights, tail lights and more. The turn signals indicate the direction in which the vehicle is going to turn, and accordingly the people nearby the vehicle can take safety measures. The brake light is a red light attached to the rear of a vehicle that lights up when the brakes are applied, serving as a warning to following drivers. The tail lights are generally mounted on the rear of a vehicle, above its bumper, and are used to make other cars aware of the presence of the vehicle, in order to travel safely in the dark. Commercial semi-truck and trailer vehicles include a significant number of lights and their proper functioning must be maintained and checked on a frequent basis.

Before operating any vehicle, checking the brake lights, turn signal lights, tail lights, etc. on a semi-truck, trailer or other vehicle is extremely important to maintain optimal roadway safety. The light system such as brake lights, turn signal lights, tail lights and more, present on the exterior of the vehicle, are operated by the vehicle's driver from the vehicle dashboard. Once the vehicle operator turns ON any of the lights, such as tail lights, the vehicle operator is required to leave the vehicle and go to the rear of the vehicle to check if the tail light is working properly. Similarly, the vehicle operator can check if other exterior light systems of the vehicle are working properly or not before operating the vehicle. It takes a lot of time to repeatedly get in and out of the vehicle to operate and then check the respective lights to determine if the lights are operational or not. This process consumes a lot of time of the vehicle operators.

Alternatively, the vehicle operators can turn ON the exterior light system on vehicles and can ask for assistance from others in checking if all the light systems of the vehicle are operational and providing real-time feedback accordingly. However, vehicle operators may not always find someone to ask for assistance. In such scenarios, the vehicle operator themselves have to manually check the light systems of the vehicle.

In case the vehicle operator is reluctant in checking the operating status of the vehicle light system, then improperly working tail lights, brake lights, turn signal lights, and other lights will leave other vehicles unaware, or inadequately alerted, of when a semi-truck or trailer is making a turn or a stop, ultimately leading to accidents.

Therefore, there exists a long felt need in the art for a device that enables the users to easily check the operating status of the vehicle light systems such as brake lights, tail lights, trailer lights, running lights, and/or turn lights, that are present on the exterior of the vehicle. There is also a long felt need in the art for a device that eliminates the need for the vehicle operator to get out of the vehicle to check if the vehicle lights are working or not. Additionally, there is a long felt need in the art for a light system checking device that eliminates the need to take multiple trips out of the vehicle, to check the operating status of different light systems of the vehicles. Moreover, there is a long felt need in the art for a device that eliminates the need to ask for assistance in checking the operating status of vehicle lights. Further, there is a long felt need in the art for a device that can be easily used and saves the time of the users/vehicle operators. Finally, there is a long felt need in the art for a vehicle light checking device that improves overall roadway safety and prevents serious accidents from occurring due to being unaware of malfunctioning vehicle lights.

The subject matter disclosed and claimed herein, in one potential embodiment thereof, comprises a key fob for wirelessly testing functionality of tail lights, turn signals, and/or brake lights on a vehicle or a trailer. The key fob includes a short-range communication transceiver for establishing a secure wireless communication channel with an on-board lighting control module of a vehicle, a brake light/tail light control button for transmitting a wireless instruction for checking functionality of brake lights/tail lights of the connected vehicle, a right turn signal control button for transmitting a wireless instruction for checking functionality of the right turn light of the vehicle, and a left turn signal control button for transmitting a wireless instruction for checking functionality of the left turn light of the vehicle. The wireless signals are converted into electrical signals by the vehicle's onboard light controller, thereby enabling the testing to be done in a user-friendly manner.

In this manner, the novel vehicle light checking device of the present invention accomplishes all of the forgoing objectives, and provides a relatively safe, easy and convenient solution to check the operating status of the vehicle light systems present on the exterior of the vehicle. The vehicle light checking device or key fob device of the present invention is also user-friendly, as it eliminates the need to take multiple trips to exit the vehicle to check if different light systems of the vehicle are operating properly. Also, the vehicle light checking device eliminates the need to ask for assistance from others to check if the vehicle lights are operating properly. Additionally, the vehicle light checking device ensures overall roadway safety by enabling the vehicle operator to check the operating status of the lights before driving the vehicle and to take corrective measures accordingly.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wireless key fob or a remote testing device. The key fob is configured for testing functionality of tail lights, turn signal lights, and/or brake lights on a vehicle or trailer. The key fob includes a short-range communication transceiver for establishing a secure wireless communication channel with an on-board lighting control module of a vehicle, a brake light/tail light control button for transmitting a wireless instruction for checking functionality of brake lights/tail lights of the connected vehicle, a right turn signal control button for transmitting a wireless instruction for checking functionality of the right turn light of the vehicle, a left turn signal control button for transmitting a wireless instruction for checking functionality of the left turn light of the vehicle and an internal battery for providing power to the internal circuitry and chips of the key fob.

In yet another embodiment of the present invention, a wireless vehicle brake lights and turn signal lights testing system is disclosed. The system includes a key fob configured to wirelessly connect to a vehicle's on-board light module and transmits wireless brake lights and turn signal lights testing instructions. The key fob further comprising a short-range communication transceiver, a brake light/tail light control button, a left turn signal control button, and a right turn signal control button. Each control button is configured to send a wireless instruction to the vehicle's on-board light module and is converted into a compatible instruction transmitted through the vehicle's light circuitry to flash the brake light/tail light, the right turn light and/or the left turn light enabling a driver to check the functionality of the rear lights and turn signal lights independently (i.e. without help of any other person).

In yet a further embodiment of the present invention, a method for checking the status of brake lights and rear turn signal lights of a vehicle is described. The method comprises: pairing a wireless key fob having a short-range wireless transceiver with on-board lighting control module of a vehicle; establishing a secure wireless communication channel between the key fob and the on-board lighting control module; transmitting a wireless instruction for checking functionality of the brake lights of the vehicle by activating a brake light control button on the key fob; flashing the brake lights of the vehicle for a pre-determined time period for indicating that the brake lights are functional; activating a right turn signal control button on the key fob, transmitting a wireless instruction for checking functionality of right turn light of the vehicle, and, flashing the right turn signal light of the vehicle for a pre-determined time period for indicating that the right turn signal light is functional; and, activating a left turn signal control button on the key fob, transmitting a wireless instruction for checking functionality of left turn light of the vehicle, and, flashing the left turn signal light of the vehicle for a pre-determined time period for indicating that the left turn signal light is functional.

In yet another embodiment of the present invention, the key fob can include touch buttons and uses Bluetooth or another short range-based communication connection. Advantageously, the key fob device and system of the present invention eliminates the need to ask for assistance to check functionality of vehicle lights or spend time getting in and out of a truck cab to check the lights while alone.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic block diagram illustrating one potential embodiment of a system for wirelessly checking tail lights, brake lights, and/or turn signal lights of the present invention in accordance with the disclosed architecture;

FIG. 2 illustrates a block diagram showing components of one potential embodiment of the key fob of the present invention in accordance with the disclosed architecture;

FIG. 3 illustrates a perspective view of one potential embodiment of the key fob of the present invention in accordance with the disclosed architecture;

FIG. 4 illustrates a perspective view showing brake lights being checked using one potential embodiment of the key fob of the present invention in accordance with the disclosed architecture;

FIG. 5 illustrates a perspective view showing a left turn signal light being checked using one potential embodiment of the key fob of the present invention in accordance with the disclosed architecture;

FIG. 6 illustrates a perspective view showing a right turn signal light being checked using one potential embodiment of the key fob of the present invention in accordance with the disclosed architecture;

FIG. 7 illustrates a flow diagram showing the steps taken to check the status of brake lights and rear turn signal lights using one potential embodiment of the key fob and system of the present invention in accordance with the disclosed architecture; and

FIG. 8 illustrates a perspective view showing brake lights of a vehicle and a connected trailer being checked using one potential embodiment of the key fob of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long felt need in the art for a device that enables the users to easily check the operating status of the vehicle light systems such as brake lights, tail lights and turn lights, that are present on the exterior of the vehicle. There is also a long felt need in the art for a device that eliminates the need for the vehicle operator to get out of the vehicle to check if the vehicle lights are working or not. Additionally, there is a long felt need in the art for a light system checking device that eliminates the need to exit the vehicle multiple times to check the operating status of different light systems of the vehicles. Moreover, there is a long felt need in the art for a device that eliminates the need to ask for assistance in checking the operating status of vehicle lights. Further, there is a long felt need in the art for a device that can be easily used and saves the time of the users/vehicle operators. Finally, there is a long felt need in the art for a vehicle light checking device that improves overall roadway safety and prevents serious accidents from occurring due to being unaware of malfunctioning vehicle lights.

The present invention, in one exemplary embodiment, is a novel wireless vehicle brake lights and turn signal lights testing system. The system includes a key fob configured to wirelessly connect to a vehicle's on-board light module and transmits wireless brake lights and turn signal lights testing instructions. The key fob also includes a short-range communication transceiver, a brake light/tail light control button, a left turn signal control button, and a right turn signal control button. Each control button is configured to send a wireless instruction to the vehicle's on-board light module that can be converted into a compatible instruction transmitted through a vehicle's light circuitry to flash the brake light/tail light, the right turn light, and/or the left turn light, thereby enabling a driver to check the functionality of the vehicle lights independently and without help of another person.

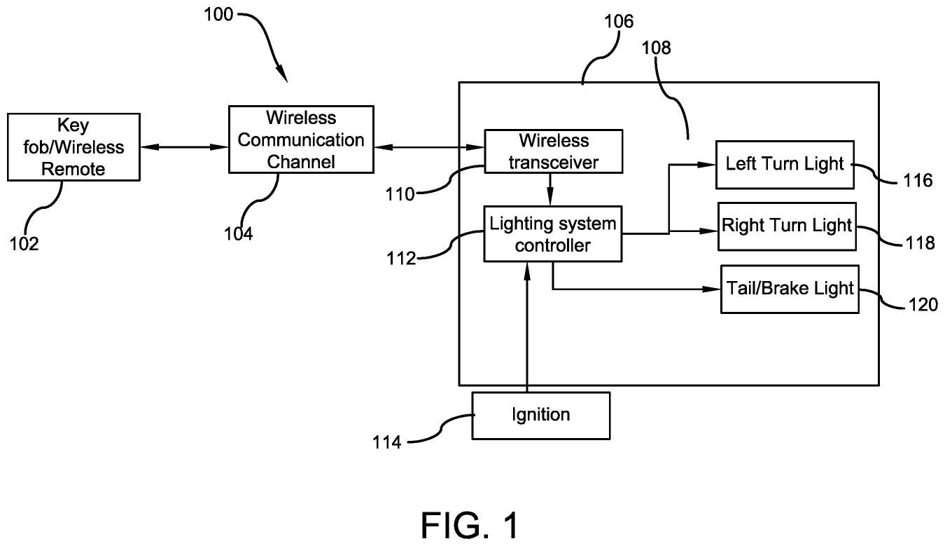

Referring initially to the drawings, FIG. 1 illustrates a schematic block diagram showing a system for wirelessly checking tail lights, brake lights and turn signals of the present invention in accordance with the disclosed architecture. The vehicle light checking system 100 of the present invention is useful for drivers for checking the tail lights, brake lights and turn signals of any vehicle such as an on-road or off-road vehicle or even of a trailer connected to a vehicle. The term “trailer” as used herein generally refers to any vehicle that can be coupled to and towed by a vehicle. For example, the trailer can be a common recreational vehicle, a utility trailer, a stock trailer or any other type of trailer. The system 100 eliminates the need to ask for assistance to check functionality of vehicle lights or spend time getting in and out of a truck cab to check the lights while alone.

The system 100 includes a multipurpose key fob 102 for independently checking tail lights, turn signals, and/or brake lights of a vehicle or trailer. The key fob 102 is wirelessly coupled to on-board vehicle lighting module 106 of a vehicle through a wireless communication channel 104 enabling a user such as a driver to go to the rear of the vehicle to check the status of the tail lights, turn signals and brake lights before starting a journey. The on-board vehicle lighting module 106 provides electronic circuitry for the internal vehicle lights and exterior lights such as the tail lights/brake lights 120, left turn light 116 and the right turn light 118. The on-board vehicle lighting module 106 is wirelessly-connected to the key fob 102 through an integrated wireless transceiver 110. The wireless transceiver 110 allows the key fob 102 to be paired with the vehicle. The wireless communication channel 104 can be based on a short-range communication protocol such as Bluetooth.

It should be noted that for authentication mechanism, a key fob ID can be used for pairing the key fob 102 with the vehicle. A microprocessor of the dashboard of the vehicle can be used for authenticating and pairing the key fob 102 to the on-board vehicle lighting module 106 of the vehicle. Once the key fob 102 is paired with the on-board vehicle lighting module 106, a lighting system controller 112 such as a vehicle lighting circuit electronic control unit (ECU) provides instructions to the corresponding light which is to be checked by the user. In one potential embodiment, before providing instructions to the tail lights/brake lights 120 and turn signal lights i.e., left turn light 116 and the right turn light 118 for checking the status, the ignition 114 of the vehicle can be checked. In case the ignition 114 is OFF, the status of the lights may be prohibited from checking. Additionally, the status of the lights can only be checked when the speed of the vehicle is zero. Instructions from the light controller 112 to the lights 116, 118, 120 are transmitted through the internal Controller Area Network (CAN) bus of the vehicle, thereby eliminating use of any additional circuitry to be added to the vehicle.

The tail lights and the brake lights 120, the left turn light 116, and the right turn light 118, can be selectively operated/actuated and checked using the key fob 102 from outside the vehicle. When an individual is standing behind the vehicle or trailer, the user can selectively activate/actuate the lights as needed to check light functionality. The key fob 102 offers a way to perform a check of the rear (and front) lights 116, 118, 120 while the driver is alone and without having to get in and out of the vehicle.

In the system 100 of the present invention, a wireless communication connection using radio waves, such as an ad hoc mode in the paired Bluetooth communication or Wi-Fi communication, or other wireless communication can be employed whereby secure communication is possible with mutual authentication being established.

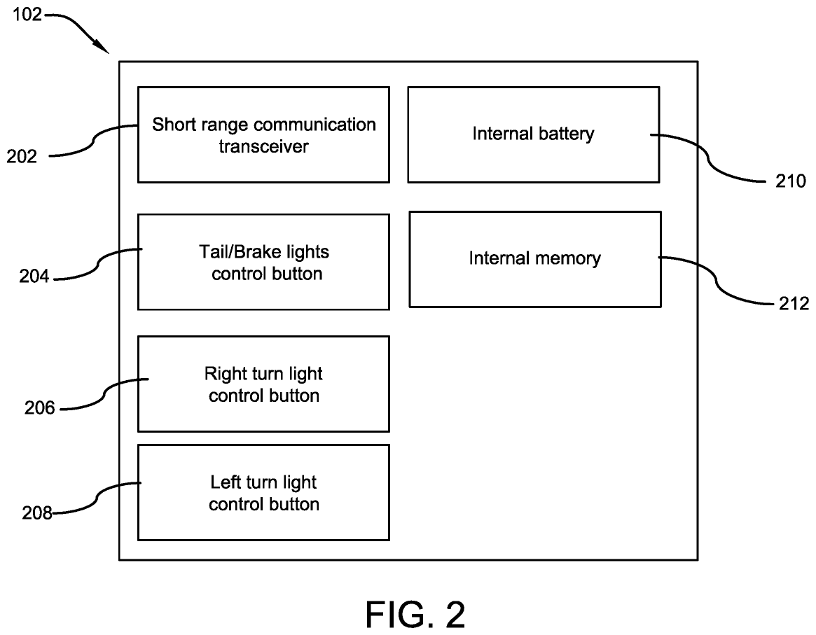

FIG. 2 illustrates a block diagram showing components of the key fob of the present invention in accordance with the disclosed architecture. The key fob 102 includes a short-range communication transceiver 202 enabling the key fob 102 to establish a wireless communication channel as described in FIG.1. The key fob 102 communicates directly with the lighting system of a vehicle using the established wireless channel.

The key fob 102 functions as a wireless remote controller for checking the tail lights/brake lights, left turn light and the right turn light of a vehicle. Further, the key fob 102 includes a plurality of control buttons enabling a user to transmit wireless instructions to a vehicle lighting control system for checking the status of the vehicle's lights. A tail light and brake light control button 204 is used for transmitting a wireless command to check the status of the tail lights/brake lights of a vehicle. A right turn signal light control button 206 is used for transmitting a wireless command to check the status of the right turn signal light of the vehicle. Similarly, left turn signal light control button 208 is used for transmitting a wireless command to check the status of the left turn signal light of the vehicle.

The control buttons 204, 206, 208 of the key fob 102 can be physical push buttons or alternatively can be touch buttons. The key fob 102 includes an internal battery 210 for providing power for the operation of the control buttons 204, 206, 208. Optionally, the key fob 102 can include an internal memory 212 to store a key fob ID or other user-related information.

The wireless instruction commands from the key fob 102 to the vehicle lighting control system of a vehicle work in a similar manner as that of an instruction sent through dashboard of the vehicle. The input of the user from the key fob transmits remote light status request, indicating the type of rear light to be checked based on the request.

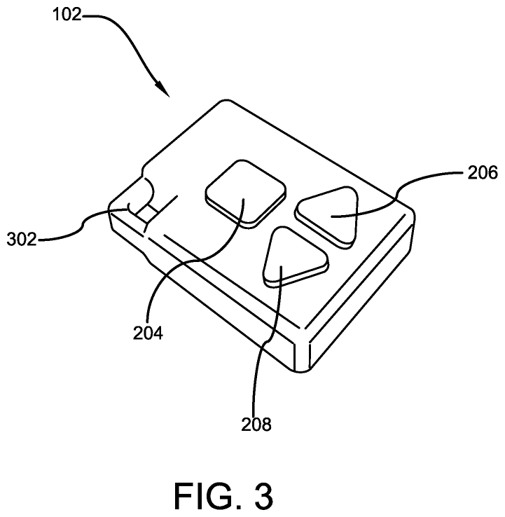

FIG. 3 illustrates a perspective view of one potential embodiment of the key fob of the present invention in accordance with the disclosed architecture. In one potential embodiment, the key fob 102 includes a keyhole 302 enabling the key fob 102 to be securely used as a keychain. A bigger central button 204 can actuate the tail lights and brake lights controller button to wirelessly transmit a request to check the status of brake lights/tail lights. Turn signal light buttons can be arrow-shaped for easy identification. A left arrow button 208 can be used for wirelessly transmitting a request to check the status of left turn signal light. Similarly, a right arrow button 206 can be used for wirelessly transmitting a request to check the status of right turn signal light.

The key fob 102 can include an internal processor enabling to receive the request signals from the individual control buttons and transmit the request through the built-in short-range communication receiver.

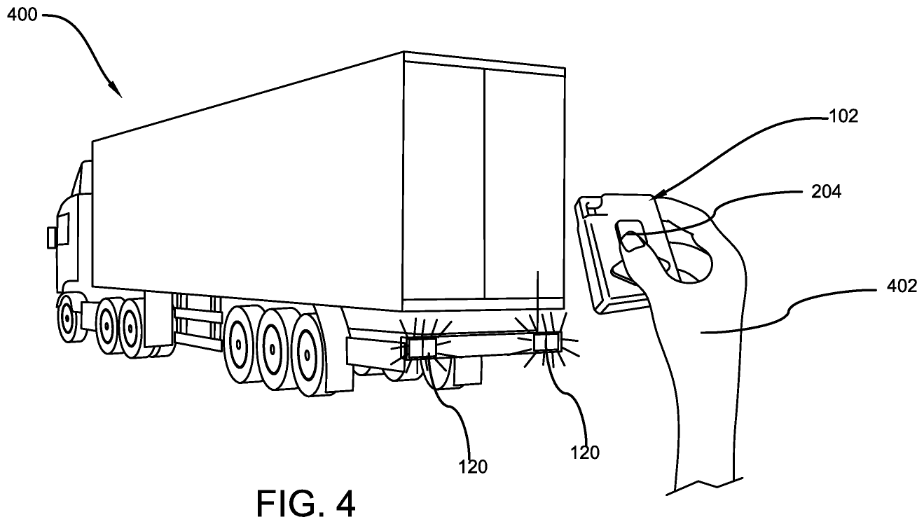

FIG. 4 illustrates a perspective view showing brake lights being checked using the key fob of the present invention in accordance with the disclosed architecture. For checking brake lights or tail lights of a vehicle 400 such as a truck cab, a driver or an operator 402 activates the brake light control button 204 of the key fob 102 enabling a wireless instruction to be transmitted to the on-board vehicle lighting module of the vehicle 400. The lighting ECU, or any other controller, controlling the brake lights 120 of the vehicle 400 turns on the lights for a predetermined period of time such as ten seconds, for example, enabling the operator to check the status of the brake lights/tail lights 120. The key fob 102 allows one person to check the vehicle brake lights that formerly required two people to accomplish.

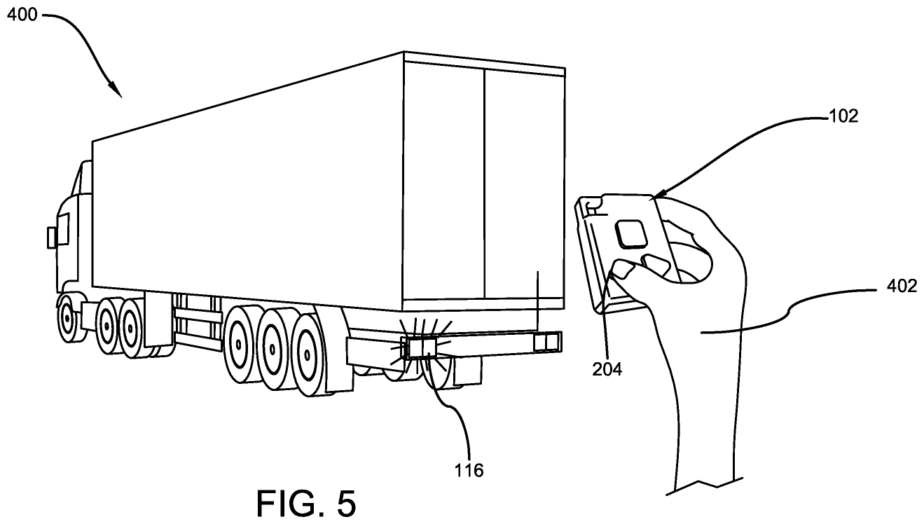

FIG. 5 illustrates a perspective view showing left turn signal light being flashed for checking using the key fob of the present invention in accordance with the disclosed architecture. For checking left turn signal light 116 of a vehicle 400 such as a truck cab, a driver or an operator 402 activates the left turn signal control button 208 of the key fob 102 enabling a wireless instruction to be transmitted to an on-board vehicle lighting module of the vehicle 400. The lighting ECU or any other controller controlling the left turn signal light 116 of the vehicle 400 turns on the left turn signal light 116 for a predetermined period of time such as five or ten seconds, thereby enabling the operator to check the status of the left turn signal light 116. The key fob 102 allows one person to check the vehicle left turn signal light that formerly required two people to accomplish.

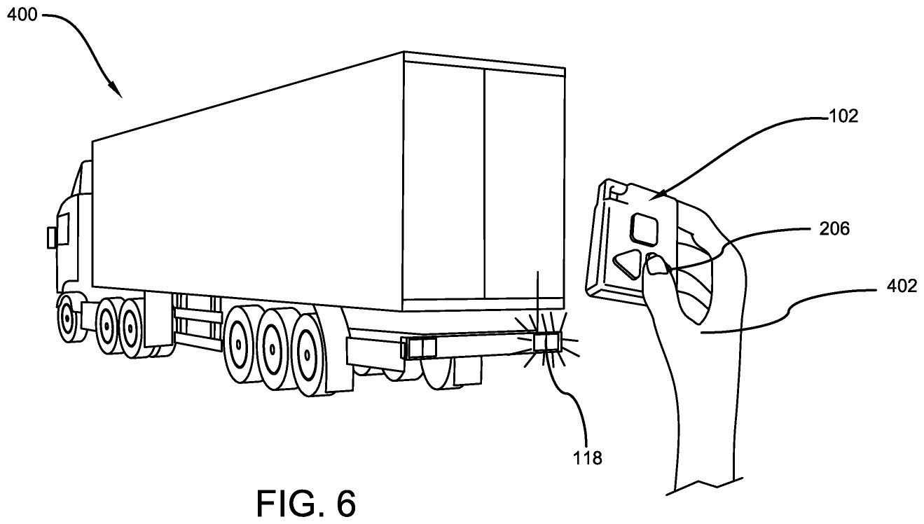

FIG. 6 illustrates a perspective view showing right turn signal light being flashed for checking using the key fob of the present invention in accordance with the disclosed architecture. For checking right turn signal light 118 of a vehicle 400 such as a truck cab, a driver or an operator 402 activates the right turn signal control button 206 of the key fob 102 enabling a wireless instruction to be transmitted to an on-board vehicle lighting module of the vehicle 400. The lighting ECU or any other controller controlling the right turn signal light 118 of the vehicle 400 turns on the right turn signal light 118 for a predetermined period of time such as five or ten seconds enabling the operator to check the status of the right turn signal light 118. The key fob 102 allows one person to check the vehicle right turn signal light that formerly required two people to accomplish.

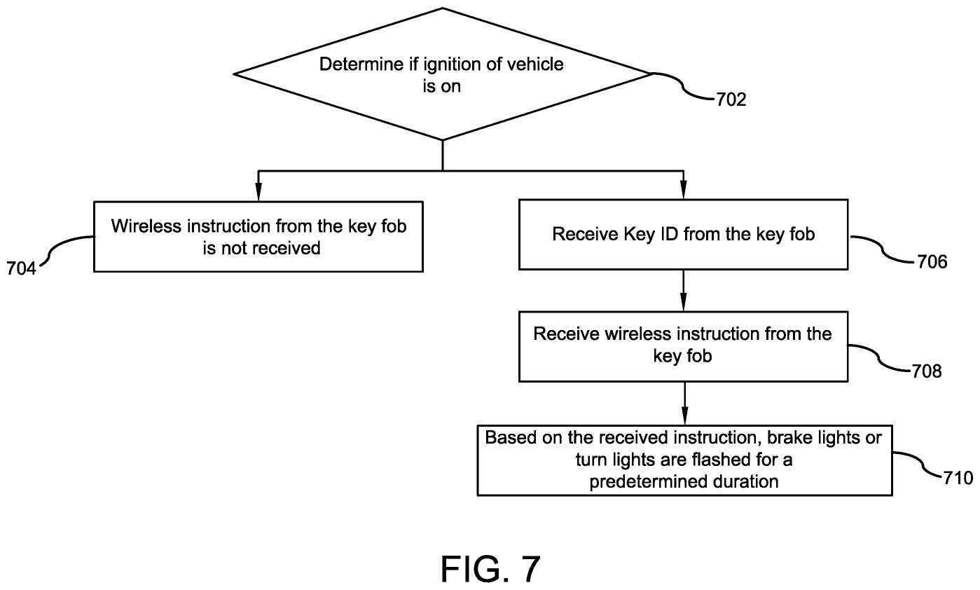

FIG. 7 illustrates a flow diagram showing steps for checking status of brake lights and/or turn signal lights using key fob and system of the present invention in accordance with the disclosed architecture. Initially, it is determined if the ignition of the vehicle whose lights are to be checked is on or off (Step 702). Additionally, speed of the vehicle can also be determined. If it is determined that the ignition is off, then the decision goes to Step 704 and the wireless instructions are not received and executed by the on-board vehicle lighting module. If it is determined that the ignition is on, a key ID of the paired key fob is received for mutual authentication of the key fob (Step 706). Once the authentication is successful, a wireless instruction from the paired key fob 708 based on the control button is received by the light ECU (Step 708). The received instruction is passed through the internal wired connection of the vehicle, therey enabling the brake lights or turn lights to be flashed for a predetermined period of time enabling an individual, such as an operator of a truck, to verify working status of the rear lights (Step 710).

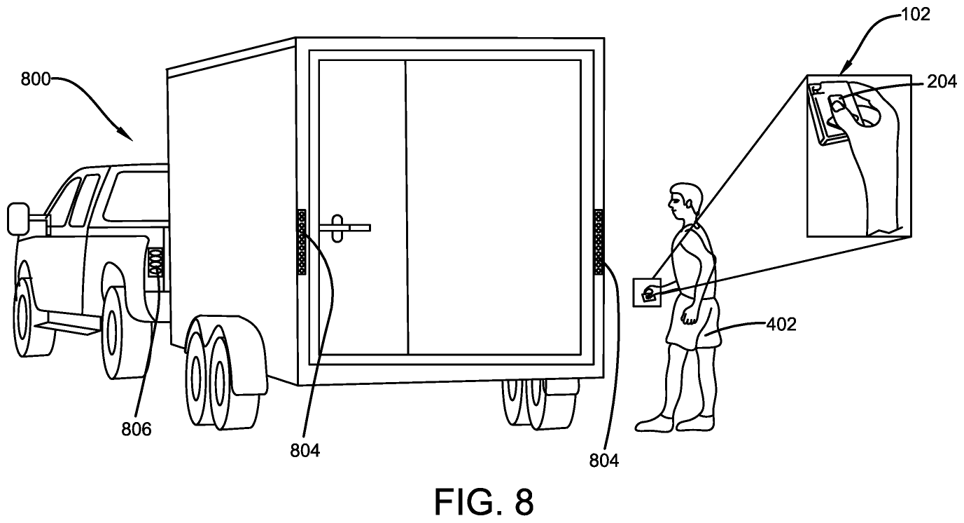

FIG. 8 illustrates a perspective view showing brake lights of a vehicle and a connected trailer being checked using the key fob of the present invention in accordance with the disclosed architecture. A trailer wiring consists of a plug connected to the tow vehicle's lighting circuitry. The trailer can include a plurality of circuits that are connected to the towing vehicle. Once connected, the lights of the trailer work in concert with the lights of the vehicle. One circuit operates the tail lights/brake lights; one circuit operates the left turn light; and one circuit operates the right turn brake light. The key fob 102 of the present invention and the wireless connection with the on-board lighting module of the vehicle 800 also allows the operator 402 to check the status of the brake lights 804 of the connected trailer 802 in addition to testing the brake lights 806 of the towing vehicle 800. The operator 402 uses the brake light control button 204 to check the status of the brake lights 804, 806 of both the trailer 802 and the vehicle 800. Similarly, the operator 402 can actuate the key fob 102 to check the status of the right and left turn signal lights of the connected trailer 802 in addition to testing the turn signal lights of the towing vehicle 800.

The system 100 and the key fob 102 of the present invention can be used in automobile manufacturing, auto-service industry, commercial manufacturing, and/or commercial service industry, thereby enabling the operators to remotely check the working status of the vehicle's lights. An operator does not have to manually ask an assistant to confirm the working status of vehicle lights while operating the vehicle independently. It is to be appreciated that tail lights as described above, can be interchanged with clearance lights, running lights, el. al., whereby the status of the clearance lights can be tested accordingly.

In one embodiment of the present invention, the key fob 102 can be in the form of a smartphone with a companion software application. The software application can provide user interface showing three control buttons for selectively activating the lights of a vehicle or a trailer for testing. A wireless communication channel is established between the wireless module of the smartphone and the vehicle's on-board light module or dashboard. The software application extends the capabilities of the physical key fob 102 of the present invention and a notification from the smartphone can be sent to maintenance service personnel of the vehicle enabling an instant escalation of the problem with the vehicle's lights. The software application can provide the functionality provided by the key fob enabling a user to use a personal smartphone or any other handheld electronic device to selectively check the functionality of the tail lights, turn signals, and brake lights of a paired vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “key fob”, “wireless key fob”, “wireless remote”, and “vehicle light checking device”, are interchangeable and refer to the key fob 102. Similarly, as used herein “vehicle lights testing system”, “vehicle light checking system”, “testing system”, and “system”, are interchangeable and refer to the vehicle lights testing system 100.

Notwithstanding the forgoing, the vehicle lights testing system 100 and key fob 102 of the present invention can be of any suitable size and configuration as is known in the art without affecting the overall concept of the invention, provided that it accomplishes the above-stated objectives. One of ordinary skill in the art will appreciate that the size, configuration and material of the vehicle lights testing system 100 and key fob 102 as shown in the FIGS. are for illustrative purposes only, and that many other sizes and shapes of the vehicle lights testing system 100 and key fob 102 are well within the scope of the present disclosure. Although the dimensions of the vehicle lights testing system 100 and key fob 102 are important design parameters for user convenience, the vehicle lights testing system 100 and key fob 102 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wireless electronic vehicle light testing device comprising:
a remote controller wirelessly connected to a vehicle ECU for checking the status of vehicle lights, wherein said remote controller includes a plurality of control buttons for transmitting at least one wireless instruction to said vehicle ECU;
at least a first control button for actuating a brake light to independently check a status of said brake light;
at least a second control button for actuating a first turn signal light to independently check a status of said first turn signal light; and
at least a third control button for actuating a second turn signal light to independently check a status of said second turn signal light.

2. The wireless electronic vehicle light testing device of claim 1, wherein said first control button actuates a tail light to independently check a status of said tail light, wherein said status of said tail light includes a test of functionality of said tail light.

3. The wireless electronic vehicle light testing device of claim 1, wherein said status of said brake light includes a test of functionality of said brake light.

4. The wireless electronic vehicle light testing device of claim 3, wherein said status of said first turn signal light includes a test of functionality of said first turn signal light.

5. The wireless electronic vehicle light testing device of claim 4, wherein said status of said second turn signal light includes a test of functionality of said second turn signal light.

6. The wireless electronic vehicle light testing device of claim 1, wherein said remote controller includes a short-range transceiver.

7. The wireless electronic vehicle light testing device of claim 6, wherein said remote controller is a key fob.

8. The wireless electronic vehicle light testing device of claim 6, wherein said remote controller includes an internal battery for powering said plurality of control buttons.

9. The wireless electronic vehicle light testing device of claim 7, wherein said remote controller includes a unique identifier for said wireless connection to said vehicle ECU.

10. A wireless electronic vehicle light testing device comprising:
a remote controller wirelessly connected to a vehicle ECU for checking the status of a vehicle light;
said controller includes a plurality of control buttons for transmitting wireless instructions to said vehicle ECU;
at least a first control button for actuating a brake light to independently check a status of said brake light;
at least a second control button for actuating a first turn signal light to independently check a status of said first turn signal light;
at least a third control button for actuating a second turn signal light to independently check a status of said second turn signal light;
said remote controller includes a short-range transceiver;
said remote controller is a key fob;
said remote controller includes an internal battery for powering said plurality of control buttons; and
said remote controller includes a unique identifier for said wireless connection to said vehicle ECU.

11. The wireless electronic vehicle light testing device of claim 10, wherein said first control button actuates a tail light to independently check a status of said tail light, wherein said status of said tail light includes a test of functionality of said tail light.

12. The wireless electronic vehicle light testing device of claim 10, wherein said status of said brake light includes a test of functionality of said brake light.

13. The wireless electronic vehicle light testing device of claim 12, wherein said status of said first turn signal light includes a test of functionality of said first turn signal light.

14. The wireless electronic vehicle light testing device of claim 13, wherein said status of said second turn signal light includes a test of functionality of said second turn signal light.

15. A method for remotely testing a vehicle and a trailer light system comprising the steps of:
connecting wirelessly a remote controller to a vehicle ECU for checking the status of said vehicle and said trailer light system;
actuating a plurality of control buttons for transmitting wireless instructions from said remote controller to said vehicle ECU;
transmitting a first wireless instruction to actuate a brake lights to independently check a status of said brake lights of said vehicle and said trailer;
transmitting a second wireless instruction to actuate first turn signal lights to independently check a status of said first turn signal lights of said vehicle and said trailer; and
transmitting a third wireless instruction to actuate second turn signal lights to independently check a status of said second turn signal lights of said vehicle and said trailer, wherein said remote controller includes a short-range transceiver.

16. The method of claim 15, wherein said remote controller includes an internal battery for powering said plurality of control buttons, and further wherein said remote controller includes a unique identifier for said wireless connection to said vehicle ECU.

17. The method of claim 15, wherein said vehicle further comprising a plug including a plurality of lighting circuits for connection to said trailer.

18. The method of claim 15, wherein said status of said brake lights includes a test of functionality of said brake lights.

19. The method of claim 18, wherein said status of said first turn signal lights includes a test of functionality of said first turn signal lights.

20. The method of claim 19, wherein said status of said second turn signal lights includes a test of functionality of said second turn signal lights.
